(19) United States
(12) Patent Application Publication
(10) Pub. No.: US 2005/0138398 A1
(43) Pub. Date: Jun. 23, 2005

(54) System of databases of personal data and a method of governing access to databases of personal data

(76) Inventor: Igor Hansen, Broxburn West Lothian (GB)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/433,615

(22) PCT Filed: Jan. 10, 2002
(86) PCT No.: PCT/PL02/00002

(30) Foreign Application Priority Data
Jan. 11, 2001 (PL) P345054

(51) Int. Cl. H04L 9/32

(52) U.S. Cl. 713/189

(57) ABSTRACT

A system utilising known storage spaces (S), for example servers or Compact Disks, is characterised by the fact that the personal data base (PDB) consists of the sum of the unitary personal databases (UPDB₁, UPDB₂, UPDB₃, UPDBₓ), each of which comprises the owner (P₁, P₂, P₃, Pₓ) of unitary personal data base (UPDB₁, UPDB₂, UPDB₃, UPDBₓ) and the storage space (S₁, S₂, S₃, Sₓ) of the owner (P₁, P₂, P₃, Pₓ) of the unitary personal data base (UPDB₁, UPDB₂, UPDB₃, UPDBₓ), wherein each storage space contains individually encrypted data objects (O′, O″, O′″, O^{y}), and the storage spaces (S₁, S₂, S₃, Sₓ) of various unitary personal database (UPDB₁, UPDB₂, UPDB₃, UPDBₓ) may be situated in one place or they may be distributed. The method of managing access to the personal data bases is based on this, that the sole owner (P) and at the same time the ultimate controller of the unitary personal data base (UPDB), especially the individual entity whom the data concern and/or whose property they are, exercises the original right of access to the storage space (S) through the granting or withdrawal of access licences (L) to data objects (O) in the storage space (S). The licence (L) determines the scope and conditions of access to the data object (O) in the storage space (S), wherein each creation of a data object in the unitary personal data base (UPDB) is automatically accompanied by an access licence (L_{O}) to that data object granted to thw owner (P) of the unitary personal data base (UPDB). Use of some data objects (O) in the storage space (S) may require the presence of more than one access licence (L). Data objects (O) in the storage space (S) are protected by symmetrical cryptography, and access to the data objects (O) in the storage space (S) is protected by asymmetrical cryptography. Access to the data takes place only at the point of use of the data (PUD) through the fetching of the data objects (O) from the storage space (S) in encrypted form and the consequent decryption of the data object (O).

The invention relates to a system of databases of personal data arranged in multiaccess configurations of various possible scopes, for example on the Internet or a local or internal network, or even within one appliance, and to a method of governing access to the personal databases by individual entities who are the owners of the unitary personal databases. These owners can be persons, groups of people, organisations or devices.

In the conventional systems used until now, the controller of the personal data concerning a subject is the entity physically owning the media used for the storage of the data. Traditional databases may be centralised or distributed with respect to the entity controlling the database, and are usually distributed with respect to the subject of the data. Due to the institutional centralisation of administration and alienation of the subject which this causes, conventional databases storing personal data, in the principle of their operation violate the rights of the individual citizen, and require additional security measures, legal safeguards, and procedures, in order to ensure the observation of these rights. The dynamic growth of the Internet and its widespread acceptance at every level and in every aspect of society have revolutionised global and regional communications, making easier the storage of information, including personal data, on servers in any place in the world, which can then be read by users from any place in the world. This ease of access to information has given rise to a significant development of systems for controlling access to data, for effectively preventing illegal access, and also of methods of verifying documents in electronic form. The problem of controlling access to data in the computer network has been widely discussed in the literature. Certain particular aspects of this problem were taken up in the description of the Polish invention nr P-331496 (PCT/GB97/00164), wherein was set out a system containing: the elements for establishing the first communications connection between a client's computer and the server's computer, elements needed to send a request from the client to the server for the obtaining of data object from the server by the client, elements in the server for selecting the requested data object from the storage memory in response to the request from the client, elements in the server to bind each data object in the memory with the service telephone number, elements in the server for identifying the telephone number of the subscriber submitting the request, other elements for the establishment of a second connection between the sever and the telephone device, elements in the server for the control of the telephone system and elements for the delivery of the requested data object from the server to the client. Data processing systems protect the data by performing an encryption operation on the plaintext of the input data object, using an encryption key, and create the encrypted ciphertext on the output. The recipient of the information in ciphertext form performs the corresponding action of decryption, using the decryption key, in order to retrieve the plaintext of data object. Encryption systems belong to two broad categories. Symmetrical cryptography uses a single key for the encryption of the data object and for its subsequent decryption. It is usually fast and inexpensive, and is used for the basic encryption of large objects, but with an eye to safety and difficulty of management, it is rarely used on its own. Asymmetrical cryptography uses a pair of keys comprising the public and the private keys. The data object encrypted using the public key can be decrypted only with the private key and vice-versa. Asymmetrical cryptography is generally stronger than symmetrical, but it is more complicated in calculation, and therefore fairly slow, lending itself to the encryption of small objects only. Moreover, there exist methods for recovering keys using asymmetrical cryptography. One of them has been set out in the description of the Polish invention P-331313 (PCT/GB97/01982), wherein is shown a system for recovering the cryptographic key, working with existing systems designed for estabilishing keys between communicating sides. Futher, one of the methods of verifying electronic documents has been set out in the description of the Polish invention P-326075 (PCT/US96/14159). That invention concerns, in principle, a system of verification of the document, a system of its archival and locating, a method of authenticating documents sent electronically, a method of authenticating the electronic document, a device for the authentication of the electronic document and a method for realising transactions through the sending of authenticated information objects and use of the device tools for the realisation of this transaction. The system ensures authenticity, privacy and integrity of the transmitted information. By authenticity should be understood the verification of the identity of the one signing the document. By privacy should be understood the protection against unauthorised access of the information contained in the document, and by integrity should be understood the facility to uncover any changes whatsoever in the content of the document. The most commonly used physical medium for the transfer of the key is a smart card with an electronic circuit. Under the designation “card” should be understood generally, any material object in the form of a portable tool, which used to carry the key or a part of the key. Smart cards are increasingly being used for performing electronic transactions. A description of one of such cards and the method of performing transactions using it is set out in the description of the Polish invention P-336938 (PCT/SE98/00897).

The object of the invention is the creation of a system of databases of personal data founded on recognised computer technologies. The application of the system will be a natural, physical incarnation of the right of every citizen to the ownership, protection and management of his own personal data. The administration of access is based on the principle that each personal database is centralised from the point of view of its owner and administrator, being the individual entity whom the data concern. At the same, time such unitary database forms a component of a distributed database from the point of view of other entities accessing the data by virtue of access licences granted for individual objects.

According to a first aspect of the invention consists of a system of personal databases using known data storage means, for example servers or compact discs, in which the database consists of the sum of unitary personal databases. Each of these abovementioned unitary personal databases comprises the owner of the unitary personal database and the storage space for the data of this unitary personal database, which the space contains individually encrypted data objects. Storage spaces for different unitary personal databases can be situated in one place, for example on one server, or can be distributed, for example on different servers. Thus, the implementation of the personal databases is founded on combining known and recognised computer technologies, but its structure transfers the management of data from the owner and manager of the storage and transmission media to the individual entity being the rightful owner of the data.

According to a further aspect of the invention consists of a method of managing access to personal data bases. There, the sole owner and ultimate manager of the unitary personal data base, especially the individual whom the data concern and/or are his own property, exercises the original right of access to his data through the handing out or recalling of access licences to data objects in the storage space. The abovementioned licences define the range and conditions of access to the data objects in the unitary personal database. A licence of access to the object for the owner of the unitary personal database compulsorily accompanies every creation of a data object in the unitary personal database. The said licence can be created automatically, and at the same time as the object and specifically for it, or it can be a preexisting licence, and the newly created object added to previously licensed data objects. Access to some data objects can require the presence of one or more licences. Data objects in the storage space are secured by symmetrical cryptography, and access to the data objects by asymmetrical cryptography. Access to the data happens in the place of use of the data, by the fetching of the data from the storage space in encrypted form and the decryption of the data object. This method of managing access to the personal databases provides the protection of each data object still before placing it in the storage space, through encrypting it with an individually generated symmetrical key in the place of this object original creation or introduction. A data object encrypted in this way is subsequently placed in the storage space. Individually generated keys mean that the cost of unauthorised access to data contained in the object or group of objects must be borne for each object or group of objects individually, whereas the placement of an object in storage space requires no special security technologies within the transmission channel. The access licence to a given object contains the value of the symmetrical key used for encrypting the object, which key is itself encrypted using the asymmetrical public key of the licensed entity. A licensee accesses the data by fetching the data object from the storage space in encrypted form, and then decrypting the data object with the symmetrical key previously decrypted from the associated license, using the private asymmetrical key of the licensee. Licences can accompany the data object in the storage space or they can be separately produced and distributed. The giving out of a licence consists of decrypting the symmetrical key in the licence of the data object's owner, through the use of the owner's private asymmetrical key, and then encrypting it again, this time with the asymmetrical public key of the licensce.

The embodiment of the invention is described with reference to the accompanying drawings in which:

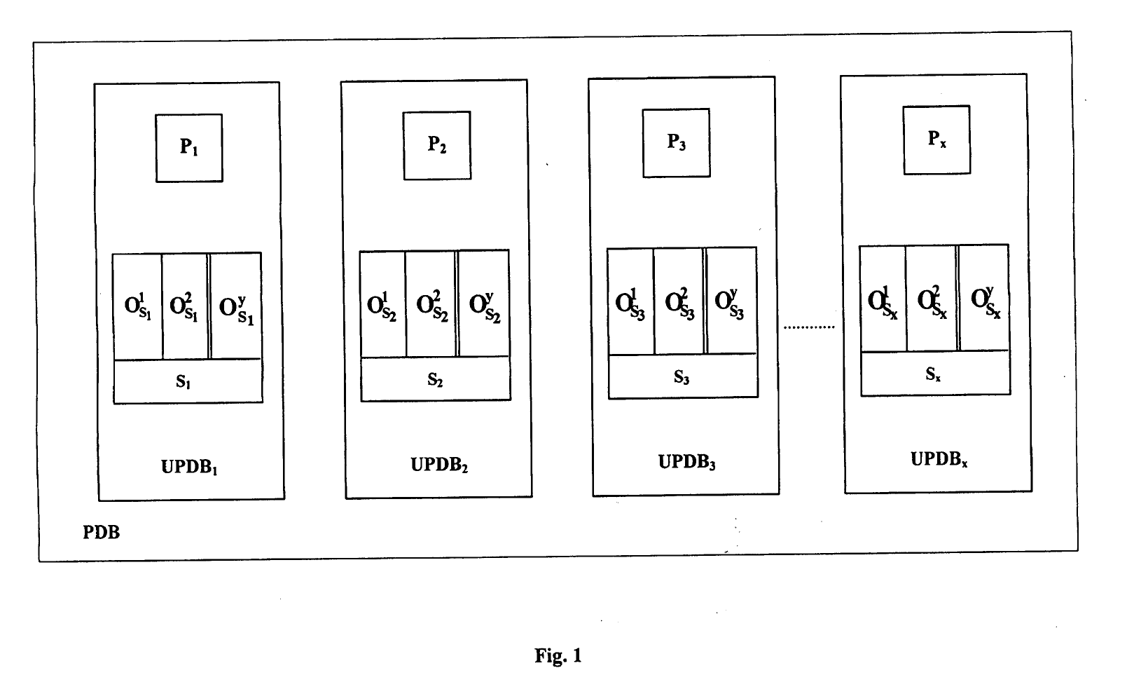

FIG. 1 sets out a schema of the system of personal databases

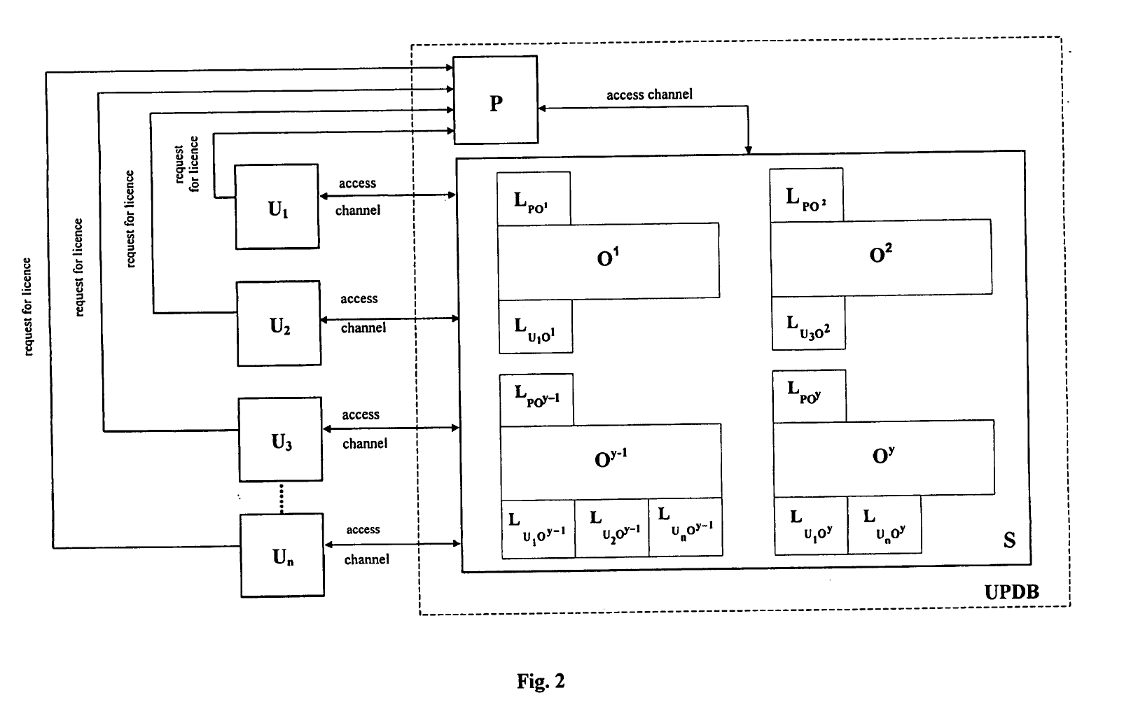

FIG. 2 shows a schema of a unitary personal data base accessed by licensed entities

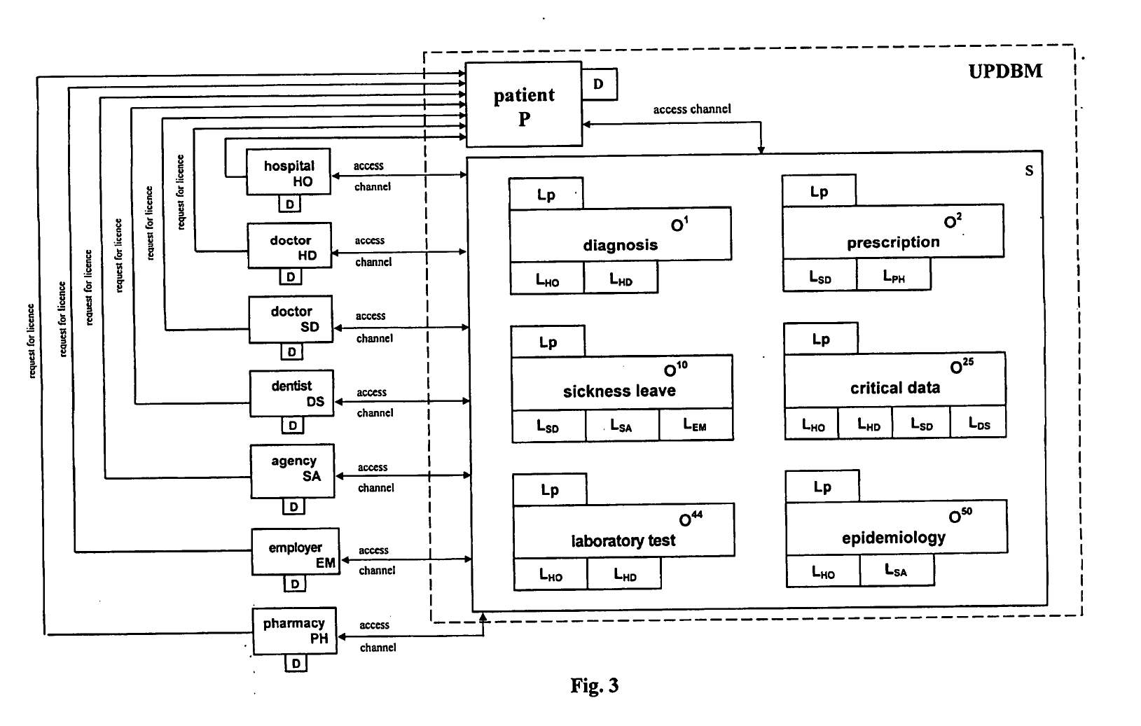

FIG. 3 shows the application of the invention for storing personal medical data in the context of the patient-owner of the unitary personal database

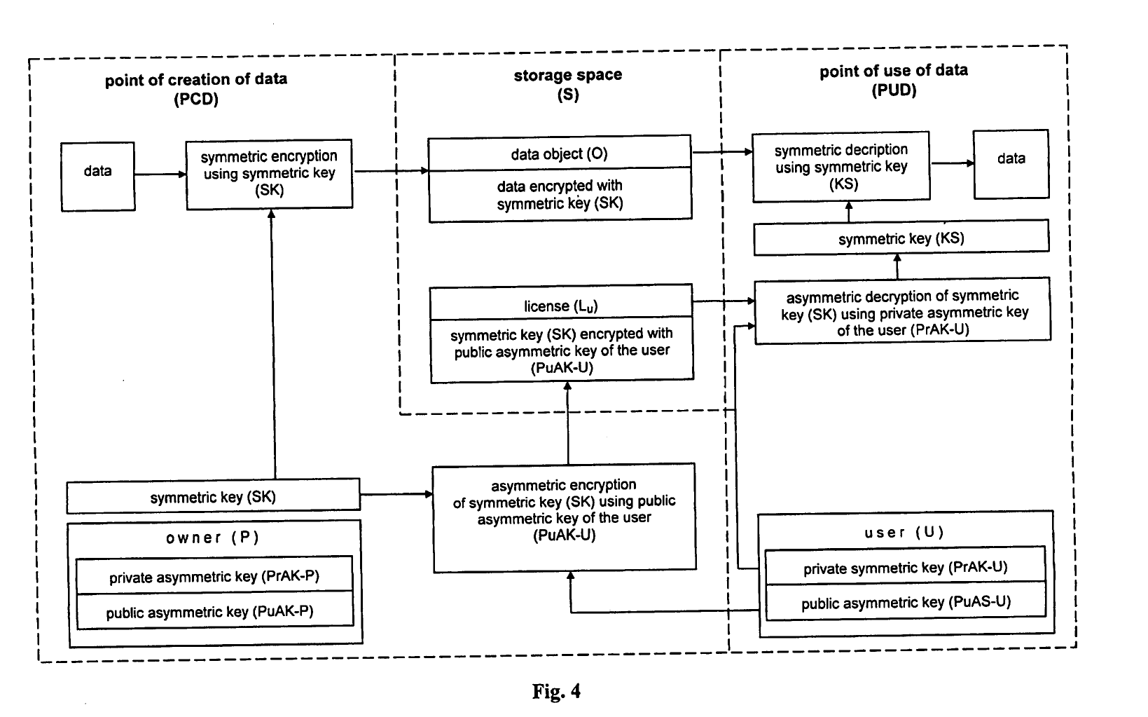

FIG. 4 shows the encryption and decryption of data within the system with the help of symmetrical and asymmetrical cryptographies.

As shown in FIG. 1, the personal data base PDB comprises the combined unitary personal databases UPDB₁, UPDB₂, UPDB₃, . . . , UPDBₓ, in which each unitary personal data base UPDB₁, UPDB₂, UPDB₃, . . . , UPDBₓ comprises the owner P₁, P₂, P₃, . . . , Pₓ of the unitary database UPDB₁, UPDB₂, UPDB₃, . . . , UPDBₓ and the storage space S₁, S₂, S₃, . . . , Sₓ of the data of owner P₁, P₂, P₃, . . . , Pₓ of the unitary data base UPDB₁, UPDB₂, UPDB₃, . . . , UPDBₓ. Each storage space S₁, S₂, S₃, . . . , Sₓ contains individually encrypted objects O¹, O², . . . , O^{y}. Storage spaces S₁, S₂, S₃, . . . , Sₓ can be situated in one place, for example on one server, on one computer hard disk or one compact disk, or they can be located in various freely chosen places, for example different servers on the Internet.

FIG. 2 shows an example unitary personal database UPDB, whose storage space S contains four data objects O¹, O², . . . , O^{y-1}, O^{y}. By default, for each of the data objects O, the owner P possesses an access licence L_{P,O}, correspondingly licence L_{P,O}_{¹} for object O¹, licence L_{P,O}_{²} for object O², licence L_{P,O}_{^{y-1}} for object O^{y-1}, and licence L_{P,O}_{^{y}} for object O^{y}. On the other hand, other users U₁, U₂, U₃, . . . , Uₙ, in order to obtain access to data object O in the storage space S, must obtain access licence L_{U,O} from owner P. In the example, the owner P provided access licence L_{U}_{₁}_{,O}_{¹} for data object O¹ for the single user U₁ only. For data object O² he provided access licence L_{U}_{₃}_{,O}_{²} for user U₃, whereas for data object O^{y-1} he provided access licence L_{U}_{₁}_{,O}_{^{y-1}} for user U₁, access licence L_{U}_{₂}_{,O}_{^{y-1}} for user U₂ and access licence L_{U}_{ₙ}_{,O}_{^{y-1}} for user Uₙ. For data object O^{y} the owner provided access licence L_{U}_{₁}_{,O}_{^{y}} for user U₁ and access licence L_{U}_{ₙ}_{,O}_{^{y}} for user Uₙ.

FIG. 3 is analogous to FIG. 2, and it shows example application of the invention to implement a unitary database of personal medical data UPDBM for the owner-patient P. Data objects O in the particular storage space S are: diagnosis O¹, prescription O², sickness leave O¹⁰, summary of critical medical data O²⁵, laboratory test result O⁴⁴ and epidemiological data O⁵⁰. The users of the data are: Hospital HO, house doctor HD, specialist doctor SD, dentist DS, pharmacy PH, employer EM and statistical agency SA. Patient P and each user: HO, HD, SD, DS, PH, EM, SA has access to a computer connected to the Internet and equipped with a device D enabling the use of cryptography. All data objects stored in the storage space S are individually encrypted; this means that for each object O a separate cryptographic key is created and used. Patient P holds access licence L_{P,O} for all objects O. Hospital HO was given access licence L_{HO,O} to diagnosis O¹, critical data O²⁵, laboratory test result O⁴⁴, and epidemiological data O⁵⁰. Other users: house doctor HD holds access licences L_{HD,O} to diagnosis O¹, critical data O²⁵ and laboratory test result O⁴⁴, specialist doctor SD holds access licences L_{SD,O} to prescription O², sickness leave O¹⁰ and critical data O²⁵, dentist DS holds access licence L_{DS,O}_{²⁵} to critical data O²⁵, statistical agency SA holds access licences L_{SA,O} to sickness leave O¹⁰ and epidemiological data O⁵⁰, employer EM holds an access licence L_{EM,O}_{¹⁰} to sickness leave O¹⁰, and pharmacy PH holds access licence L_{PH,O}_{²} to prescription O². The given example does not exhaust the possibilities of utilising the system of personal medical databases UPDBM, but only indicates the method of organisation and management of this system. This is because patient P may provide access licences L to other selected entities on individually set conditions. Licence L can be granted for an indefinite period, it can be made non-revocable to guarantee access by doctors to their own entries or it can be on a one time basis, for example to a doctor outwith one's place of residence. Prescription O² can be made accessible to pharmacy PH for the purpose of dispensing medicine, registering this transaction and reconciling the payment with the relevant health care agency. Critical data O²⁵, in situations demanding immediate intervention, can be automatically made accessible to the nearest hospital, which allows it to be appropriately prepared for the reception of the patient P. Epidemiological data O⁵⁰ can be made accessible to selected agencies, while not allowing access to the object containing patient P identity, thus preserving his anonymity. It is implicit, that each licensed entity may obtain access to the data of other owners, stored on the same or other servers, upon obtaining licences from those owners.

FIG. 4 sets out an example of the encryption of data into object O and the granting of access licence L_{U} to user U by owner P. In the point of the creation of the data PCD the owner encrypts his data with the individually generated symmetric key SK, making data object O. He encrypts key SK with the asymmetric public key PuAK-U of user U, making access licence L_{U}. The data object O and access licence L_{U} thus created are placed in storage space S. To access the data, user U fetches data object O and access licence L_{U} to the place of use of the data PUD, where by means of his own private asymmetric key PrAK-U he decrypts the symmetric key SK, with the help of which he then decrypts the data of object O. Owner P likewise creates and uses his own licence L_{P} using his own asymmetric keys, public PuAK-P and private PrAK-P.

The system of personal databases PDB according to the invention can be successfully used for storing documents of especial value to the owner P. Such a database enables the secure storage of documents, for example those which loss through theft, misplacement or fire would have serious material or legal consequences, or cause a strong feeling of personal loss. Personal documents may be stored in unitary database UPDB by the owner P himself, legal documents such as notarial acts or birth certificates should be first digitally signed by a notary, and identity documents such as an identity card, a passport, driver's licence, certificate of professional qualification or of academic status, should be stored in the database UPDB as duplicates first digitally signed by the body issuing the original document. Documents stored in the base UPDB can be accessed by the owner P anywhere, where the need for them to be shown arises, for example on a national border when the original passport has been lost or stolen. Strong cryptographic technologies will make documents more immune to forgery than paper or plastic based originals and may even end up being used in place of those originals. The system of personal databases PDB may be used to protect and licence intellectual property. Computer programmes, digitally recorded audio items, literature, graphic productions, teaching materials and others can be encrypted symmetrically and stored in the unitary personal data base UPDB of the original owner P: the author, agent or studio. From there, the owner P can make these items individually available other licensed users U. For the distribution of encrypted data objects O, especially repeatedly usable ones, like audio or video material, use can be made of mass media such as the Internet, compact discs, kiosks or Digital Audio Broadcast channels. At this point, the distributed data object O still belongs only to unitary personal database UPDB of owner P, as its content is only accessible to him and is not accessible by unauthorised entities. Obtaining licence L makes data object O accessible to user U. In the case of obtaining many licences L to many different data objects O from one or more owners P, such user U becomes the manager of a distributed personal data base comprising a collection of different data objects O, to which user U gains access by means of his private asymmetrical key PrAK-U.

Another example of utilisation of the invention is in the field of controlling access to motor vehicles, especially motorcars. There, the ultimate manager, and the licensing entity is the owner of the vehicle. The collection of data objects, i.e. the unitary database UPDB contains the full range of functions of the vehicle, in which each function can be treated as a single data object O; the data recorded therein allow the controlling of the relevant function, and the readings provide indicators of its use. The original owner P of the vehicle and of UPDB database within can issue licences L to other entities, modify or revoke them. These may be licences for selected functions with established limits of working, for example limiting speed for young drivers. The full range of functions of the vehicle accessible to the original owner P is his unitary personal database UPDB. The collection of access licences to many different vehicles, composed of licences given to a third party by the original owners of the vehicles, comprises the distributed personal database of access of that party.

It is evident, that the system of personal databases PDB, as also the unitary personal data base UPDB, can contain data objects O from many fields. The same asymmetric key pair can be used to access personal medical data, digital copy of one's passport, to open a musical file one has purchased, to direct a whole fleet of company cars or to manage access to a private vehicle.

1. A system of databases of personal data using known storage media, for example servers or compact discs, characterised in that the database of personal data (PDB) comprises the sum of unitary personal databases (UPDB₁, UPDB₂, UPDB₃, . . . , UPDBₓ) of which each is made up of the owner (P₁, P₂, P₃, . . . , Pₓ) of unitary personal database (UPDB₁, UPDB₂, UPDB₃, . . . , UPDBₓ) and storage space (S₁, S₂, S₃, . . . , Sₓ) for the data of the owner (P₁, P₂, P₃, . . . , Pₓ) of the unitary personal database (UPDB₁, UPDB₂, UPDB₃, . . . , UPDBₓ), and where each storage space (S₁, S₂, S₃, . . . , Sₓ) contains individually encrypted data objects (O¹, O², O³, . . . , O^{y}).

2. A system according to claim 1 characterised in that the storage spaces (S₁, S₂, S₃, . . . , Sₓ) of different unitary databases of personal data (UPDB₁, UPDB₂, UPDB₃, . . . , UPDBₓ) are situated in one place.

3. A system according to claim 1 characterised in that the individual storage spaces (S₁, S₂, S₃, . . . , Sₓ) of different unitary databases of personal data (UPDB₁, UPDB₂, UPDB₃, . . . , UPDBₓ) are distributed.

4. A method of managing access to the database of personal data comprising a collection of unitary databases of personal data, characterised in that the sole owner and ultimate manager of the unitary database of personal data, specially an individual whom these data concern and/or are his property, exercises the original right of access to the storage space through provision or withdrawal of access licences to data objects within that storage space.

5. A method according to claim 4 characterised in that the licence defines the scope and conditions of access to the data objects within the unitary database of personal data.

6. A method according to claim 4 characterised in that the creation of a data object in the unitary database of personal data is automatically accompanied by the creation of an access licence for that object for the owner of that unitary database of personal data.

7. A method according to claim 5 characterised in that access to certain data objects in the storage facility requires the presence of one licence.

8. A method according to claim 5 characterised in that access to certain data objects requires the presence of more than one licence.

9. A method according to claim 4 or claim 5 characterised in that the data objects in the storage space are encrypted using symmetrical cryptography, and access to data objects in the storage space is managed through asymmetrical cryptography.

10. A method according to claim 9 characterised in that access to data takes place in the place of use of the data through the fetching of the data object from the storage space in encrypted form and then the decrypting of the data object.
